(19) United States
(12) Patent Application Publication
(10) Pub. No.: US 2013/0087103 A1
(43) Pub. Date: Apr. 11, 2013

(54) METHOD AND APPARATUS FOR ENHANCING OF ANIMAL PRODUCTION IN ANIMAL CONFINEMENT HOUSES

(71) Applicant: Mark Glazman, Columbus, OH (US)

(72) Inventor: Mark Glazman, Columbus, OH (US)

(21) Appl. No.: 13/269,876

(22) Filed: Oct. 10, 2011

(51) Int. Cl. A01K 1/00; A01K 29/00

(52) U.S. Cl. 119/448

(57) ABSTRACT

A method and apparatus for enhancing animal production in the animal confining house for raising the animals by improving health of the animals and reducing their rate of respiratory infections using an aerosol. The apparatus includes an animal confining house, containing an enclosed structure, a fan means, an aerosol generating means, and an aerosol delivery means.

### FIELD OF THE INVENTION

This invention is related to enhancing of animal production in animal confinement houses for raising animals by improving health of the animals and reducing their rate of respiratory infections.

### BACKGROUND OF THE INVENTION

The respiratory infections in animal confinement houses is a serious problem in agriculture. The control of respiratory diseases has become increasingly important with an growing number of modern animal houses containing thousands of animals confined in close proximity to each other. In modern animal production facilities it is increasingly important to improve the productivity and inhibit diseases caused by respiratory infections.

Increased demands for organic product, as well as the push for the restriction of the use of antibiotics and hormones on animals have created a need for an inexpensive, efficient method and apparatus for enhancing of animal production in animal confining houses.

The enhancement of animal production in animal confining houses can be achieved by the reduction of infectious diseases which would result in an improvement of the health of the animals, and animal productive functions.

The enhancement of production is particularly important for in a large modern poultry houses, usually twenty thousand to twenty-five thousand chickens may be housed at a given time. In large poultry houses the respiratory infections could quickly spread and affect thousands of animals. In extreme cases, such as drug resistant infections, significant animal mortality may result. Even if mortality does not result, the illness can produce significant physiological stress on the chickens that results in inhibited growth, and reduced egg production. This may be psychologically harmful to the chickens, which further inhibits their physical development. Weak health and infections of may result in significant financial losses to an animal farmer.

The production of animal farm could be improved by the strengthening of protective properties of organism and by limiting spread of airborne infections. To prevent disease in and stimulate growth of animals, antibiotics have been used. Fed at a sub-therapeutic level, antibiotics have been found to have beneficial effects. However, there are many negative aspect associated with antibiotic use, such as consumer acceptance and selection of resistant bacteria. For instance, rising scientific evidence shows that using antibiotics in livestock feed can lead to antibiotic-resistant bacteria that can be transferred to people, making it difficult to treat certain infections.

The protective properties of organisms against respiratory infections viral or bacterial origination could be improved by a vaccination.(U.S. Pat. Nos. 5,004,607, 6,936,250) However, the effectiveness of current vaccines is limited in the prevention of known and emerging respiratory infections. The evidence indicates that the virus can continue to replicate in clinically healthy vaccinated birds, which reduces the effectiveness of vaccination programs.

The spread of air borne infections in animal houses could be controlled by proper ventilation and also by means of air purification. U.S. Pat. No. 6,156,268, and U.S. Pat. No. 6,810,832 disclose automated animal houses comprising ventilation system having fans, ionizers, and ozone generators. Even when fans of the ventilation system are running at 100% capacity they are not sufficient to purify the air in the animal house and limit a transmission of respiratory infections.

To further improve the quality of the air the U.S. Pat. No. 6,156,268 and U.S. Pat. No. 6,810,832 disclose the animal house has air ionizers and ozone generators. The disadvantage of these inventions is that for killing or removing airborne viruses and bacteria in animal houses having ionizers are not sufficient. For better air purification an ozone generator in animal house was disclosed in U.S. Pat. No. 6,156,268 and U.S. Pat. No. 6,810,832. An air purification requires significant concentration of ozone in the air in the animal house. The concentrations of ozone in the air which are effective for killing airborne virus and bacteria are dangerous for animals and humans, because of carcinogenic effect of ozone.

The U.S. Pat. No. 6,481,380 discloses an animal house with ventilation system having fans and dampers are used to maintain a relatively constant, preferably positive, pressure in a poultry house, resulting in increase in egg production. While this invention increases egg production it lacks of means of air purification and cannot effectively reduce the transmission of airborne infections in densely populated animal houses.

The high risk of spread of respiratory infection in large animal houses confining thousands of animals indicates however, that the large animal houses provide ventilation and air purification systems which are inadequate in controlling the spread of airborne infections in animal houses.

Treatment of respiratory diseases of humans by inhalation of fine salt particles (halotherapy) in salt caves or salt mines has been practiced for centuries in Eastern Europe. The efficacy of this treatment is associated with the unique environment within the salt caves and mines. The main curative factor is an air saturated with dry sodium chloride aerosol with particles. The salt aerosol is formed by the convective diffusion of the fine salt particles from surfaces of salt caves.

The special rooms with salt walls and aerosolized salt for four to six individuals, sitting in armchairs, or special haloinhalators were used for the inhalation. Recent studies indicated that regular use of haloinhalators by human volunteers could prevent the common cold and also could provide relief of symptoms of common cold. Upon applying haloinhalations within a three-month period twice a week on preventive basis the morbidity rate of common colds was four times less in treatment group as compared with the control group.

U.S. Pat. No. 5,881,720 discloses a method of providing halotherapy to the upper portion of the lower respiratory tract includes the steps of operating a dispenser and inhaling. The dispenser contains a dry sodium chloride powder. The user operates the dispenser to release a dosage of the powder for inhalation when the dispenser is aimed into the user's mouth. While the patient was not inconvenienced by having to remain in a cave, or in the special salt room for an extended period, the patient was effectively engaged in a use of the inhaler. The use of salt caves, salt rooms or inhalators became customary for humans. However, these methods and apparatuses are not practical and commercially useful for the treatment of animals.

While known animal houses have provided a variety of means for air purification in animal houses and known methods and devices provided halotherapy for humans, these known products have not been fashioned to enhancing of animal production in animal confinement houses by improving health of the animals and reducing a rate of respiratory infections.

It is therefore desirable in the industry to provide a method and apparatus for enhancing of animal production in animal confinement houses by improving health of the animals and reducing a rate of respiratory infections with application of natural factors.

### SUMMARY OF THE INVENTION

It is an object of the present invention to provide an animal house for raising animals which has a facility for housing animals which has walls, a roof, a flooring and indoor air which is separated from outdoor air by the facility.

It is an object of the present invention to provide the animal house for raising animals includes a ventilation system comprises electrically powered fans, for circulating indoor air in the animal house, for drawing influent ambient air into the animal house, and for discharging effluent air out of the animal house.

It is an object of the present invention to provide the animal house for raising animals includes aerosol generating means, mounted at said facility. The aerosol generating means generate aerosol, for discharging into said indoor air; said aerosol having a particle size range from about 0.5 microns to about 15 microns, said aerosol particle size range enabling said aerosol to target said animals respiratory tract, to reduce a rate of respiratory infections, to improve a productivity and the health of animals in said facility.

It is a further object of the present invention to provide the animal house for raising animals includes aerosol delivery means comprising of aerosol transporting air, conduits, and dispensers; said conduits mounted at said facility and connected at the receiving end to said aerosol generating means and at the discharging end to said dispensers to convey and discharge said aerosol in said indoor air in said facility to facilitate the inhalation of said aerosol by animals in said animal house. The electrically powered fans move indoor air containing said aerosol inside of the facility to facilitate the inhalation of said indoor air containing said aerosols by animals in said animal house.

It is a further object of the present invention to provide an animal house where dispensers discharging said aerosol in said indoor air are situated in incoming air flow.

It is a further object of the present invention to provide an animal house where dispensers discharging said aerosol in said indoor air are situated in circulating air flow in the facility.

It is a further object of the present invention to provide the aerosol composed of sodium chloride.

It is a further object of the present invention to provide the sodium chloride which includes dry sodium chloride.

It is a further object of the present invention to provide the aerosol comprised of medications.

It is a further object of the present invention to provide the medications comprised of vaccines, and disinfectants, which are able to protect animals from infections.

It is an object of the present invention to provide the method of enhancing of animal production in animal confinement houses said method comprising the steps of:

operating a ventilation system comprising electrically powered fans, for circulating indoor air in the animal house, for drawing influent ambient air into the animal house, and for discharging effluent air out of the animal house;

operating a aerosol generator producing aerosol having a particle size range from about 0.5 microns to about 15 microns,

operating said aerosol delivery means comprising of aerosol transporting air, a conduits, and dispensers; said conduits mounted at said facility and connected at the receiving end to said aerosol generating means and at the discharging end to said dispensers to convey and discharge said aerosol in said indoor air in said facility to facilitate the inhalation of said aerosol by animals in said animal house,

exposing animals in animal confinement houses to said aerosol in said indoor air during a treatment session.

It is an object of the present invention to provide the method of enhancing of animal production in animal confinement houses wherein aerosol generating means and aerosol delivery means work during the time when ventilation system is in operation.

It is an object of the present invention to provide the method of enhancing of animal production in animal confinement houses wherein said treatment session lasts from about 0.1 hour to about 6 hours.

It is an object of the present invention to provide the method of enhancing of animal production in animal confinement houses wherein the said treatment session applied continuously from about 3 times a day to about one time a week.

It is an object of the present invention to provide the method of enhancing of animal production in animal confinement houses wherein said aerosol is comprised of sodium chloride.

It is an object of the present invention to provide the method of enhancing of animal production in animal confinement houses wherein said sodium chloride includes dry sodium chloride.

It is another object of the present invention to provide the method of enhancing of animal production in animal confinement houses wherein the concentration of said sodium chloride in said indoor air during said treatment session is maintained from about 0.1 mg/m3 to about 12 mg/m3.

It is an object of the present invention to provide the method of enhancing of animal production in animal confinement houses wherein said aerosol includes medications.

It is another object of the present invention to provide the method of enhancing of animal production in animal confinement houses wherein said medications includes vaccines, and disinfectants, which are able to protect animals from infections.

### BRIEF DESCRIPTION OF THE DRAWINGS

The invention will be described by way of example and with reference to the accompanying drawings in which:

FIG. 1 is a schematic view of a preferred embodiment of the invention showing an animal house for raising animals with a cutaway view to expose the components of the animal house for raising animals;

FIG. 2 is a schematic view of a preferred embodiment of the invention showing an animal house for raising animals with a roof removed to expose all its components.

### DETAILED DESCRIPTION OF THE INVENTION

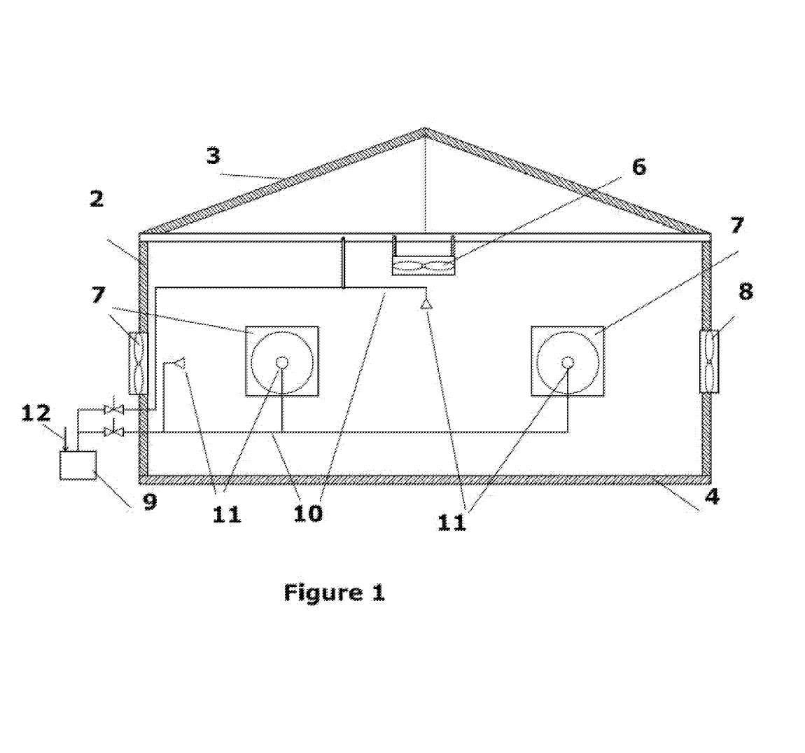

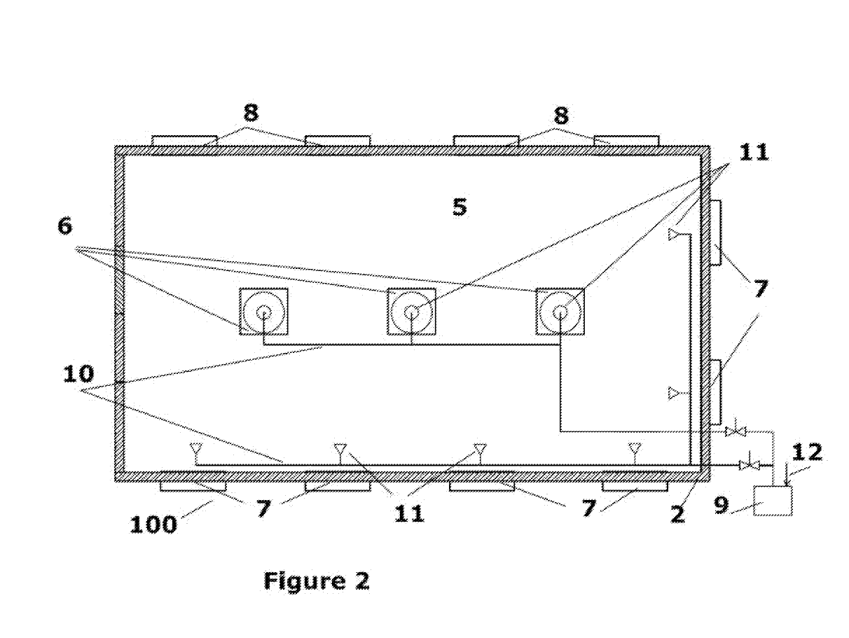

The present invention provides an animal house for raising animals, includes a facility generally referred to by reference 100. The preferred embodiment of the invention is shown in FIG. 1, and FIG. 2.

The animal house for raising animals includes facility 100 having: walls 2, a roof 3, a flooring 4, and indoor air 5, which is separated from outdoor air by the facility 100. The animal house for raising animals has a ventilation system comprises electrically powered fans for circulating indoor air in the animal house 6, for drawing influent ambient air into the animal house 7, and for discharging effluent air out of the animal house 8. The animal house for raising animals includes aerosol generating means 9, mounted at the animal house.

The animal house for raising animals includes aerosol delivery means comprising of aerosol transporting air 12, conduits 10, and dispensers 11. The conduits 10 mounted at the facility and connected at the receiving end to the aerosol generating means 9, and at the discharging end to the dispensers 11 to convey and discharge said aerosol in the indoor air 5 in the facility 100 to facilitate the inhalation of said aerosols by animals in said animal house. The electrically powered fans 6, 7, and 8 move indoor air 5 containing the aerosol inside of the facility to facilitate the inhalation of the indoor air 5 containing aerosol by animals in the animal house.

According to the preferred embodiment the aerosol has a particle size range from about 0.5 microns to about 15 microns, the aerosol particle size range is enabling the aerosol to target animals respiratory tract, to reduce a rate of respiratory infections, to improve a productivity and the health of animals in the animal house for raising animals.

According to the preferred embodiment the aerosol being comprised of sodium chloride.

According to the preferred embodiment said sodium chloride includes dry sodium chloride.

Preferably, the aerosol being comprised of medications.

According to the preferred embodiment said medications include vaccines, and disinfectants, which are able to protect animals from infections.

According to the preferred embodiment the dispensers 11 discharging the aerosol are situated in incoming air flow originated by electrically powered fans for drawing influent ambient air into the animal house 7 to facilitate a mixing discharged aerosol with indoor air 5.

According to the preferred embodiment the dispensers 11 discharging the aerosol in the indoor air 5 are situated in circulating air flow originated by electrically powered circulation fans 6.

According to the preferred embodiment the method of enhancing of animal production in animal confinement houses for raising animals is comprising the steps of:

operating a ventilation system comprising electrically powered fans for circulating indoor air in the animal house 6, for drawing influent ambient air into the animal house 7, and for discharging effluent air out of the animal house 8;

operating an aerosol generator producing aerosol having a particle size range from about 0.5 microns to about 15 microns,

operating said aerosol delivery means comprising of aerosol transporting air 12, conduits 10, and dispensers 11; the conduits mounted at the facility and connected at the receiving end to the aerosol generating means 9 and at the discharging end to the dispensers 11 to convey and discharge the aerosol in the indoor air 5 in the facility 100 to facilitate the inhalation of said aerosol by animals in said animal house,

exposing animals in animal confinement houses to the aerosol in said indoor air 5 during a treatment session.

According to the preferred embodiment the aerosol generating means and aerosol delivery means work during the time when ventilation system is in operation. According to the preferred embodiment the treatment session lasts from about 0.1 hour to about 6 hours. Preferably the treatment sessions applied continuously from about 3 times a day every day to about one time a week every week.

According to the preferred embodiment said aerosol is comprised of sodium chloride.

According to another preferred embodiment said sodium chloride includes dry sodium chloride.

According to preferred embodiment the concentration of said sodium chloride in said indoor air during said treatment session is maintained from about 0.1 mg/m3 to about 12 mg/m3.

According to another preferred embodiment said aerosol includes medications.

According to preferred embodiment said medications includes vaccines, and disinfectants, which are able to protect animals from infections.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. An animal house for raising animals, comprising:
a facility comprising a dwelling for housing animals, said facility having walls, a roof, a flooring, an indoor air;
a ventilation system comprising electrically powered fans, for circulating indoor air in the animal house, for drawing influent ambient air into the animal house, and for discharging effluent air out of the animal house;
aerosol generating means mounted at said facility for generating aerosol for discharging into said indoor air; said aerosol having a particle size range from about 0.5 microns to about 15 microns, said aerosol particle size range enabling said aerosol to target said animals respiratory tract, to reduce a rate of respiratory infections, to improve a productivity and the health of animals in said facility; and
aerosol delivery means comprising of aerosol transporting air, conduits, and dispensers; said conduits mounted at said facility and connected at the receiving end to said aerosol generating means and at the discharging end to said dispensers to convey and discharge said aerosol in said indoor air in said facility to facilitate the inhalation of said aerosols by animals in said animal house.

2. The animal house for raising animals recited in claim 1 wherein aerosol dispensers are situated in incoming air flow.

3. The animal house for raising animals recited in claim 1 wherein aerosol dispensers are situated in circulating air flow in the facility.

4. The animal house for raising animals recited in claim 1 wherein said aerosol is comprised of sodium chloride.

5. The animal house for raising animals recited in claim 1 wherein said sodium chloride includes dry sodium chloride.

6. The animal house for raising animals recited in claim 1 wherein said aerosol is comprised of medications.

7. The animal house for raising animals recited in claim 6 wherein said medications include vaccines, and disinfectants, which are able to protect animals from infections.

8. A method of enhancing of animal production in animal confinement houses said method comprising the steps of:
operating a ventilation system comprising electrically powered fans, for circulating indoor air in the animal house, for drawing influent ambient air into the animal house, and for discharging effluent air out of the animal house;
operating an aerosol generator producing aerosol having a particle size range from about 0.5 microns to about 15 microns;
operating said aerosol delivery means comprising of aerosol transporting air, a conduits, and dispensers; said conduits mounted at said facility and connected at the receiving end to said aerosol generating means and at the discharging end to said dispensers to convey and discharge said aerosol in said indoor air in said facility to facilitate the inhalation of said aerosol by animals in said animal house; and
exposing animals in animal confinement houses to said aerosol in said indoor air during a treatment session.

9. The method of enhancing of animal production in animal confinement houses recited in claim 8 wherein aerosol generating means and aerosol delivery means work during the time when ventilation system is in operation.

10. The method of enhancing of animal production in animal confinement houses recited in claim 8 wherein said treatment session lasts from about 0.1 hour to about 6 hours.

11. The method of enhancing of animal production in animal confinement houses recited in claim 8 wherein the said treatment session applied continuously from about 3 times a day to about one time a week.

12. The method of enhancing of animal production in animal confinement houses recited in claim 8 wherein said aerosol is comprised of sodium chloride.

13. The method of enhancing of animal production in animal confinement houses recited in claim 12 wherein said aerosol includes dry sodium chloride.

14. The method of enhancing of animal production in animal confinement houses recited in claim 8 wherein the concentration of said sodium chloride in said indoor air during said treatment session is maintained from about 0.1 mg/m3 to about 12 mg/m3.

15. The method of enhancing of animal production in animal confinement houses recited in claim 8 wherein said aerosol includes medications.

16. The method of enhancing of animal production in animal confinement houses recited in claim 15 wherein said medications includes vaccines, and disinfectants, which are able to protect animals from infections.
